(19) United States
(12) Patent Application Publication
(10) Pub. No.: US 2020/0400019 A1
(43) Pub. Date: Dec. 24, 2020

(54) DRUM-TYPE SHEARER LOADER, AND A SHEARER DRUM OF A DRUM-TYPE SHEARER LOADER

(71) Applicant: Lloyd Dynamowerke GmbH, Bremen (DE)

(72) Inventors: Volker QUAST, Erkrath (DE); Sepp LACHENMAIER, Mondorf les Bains (LU); Falk LAUBE, Berlin (DE); André MARCIC, Kiel (DE); Jörg RECKTENWALD, Merzig (DE)

(21) Appl. No.: 16/970,133

(22) PCT Filed: Feb. 12, 2019
(86) PCT No.: PCT/EP2019/053414

§ 371 Date: Aug. 14, 2020

(30) Foreign Application Priority Data
Feb. 16, 2018 (DE) 10 2018 103 527.6

(51) Int. Cl. E21C 31/02; E21C 25/10; F16H 1/46; H02K 1/20; H02K 7/116; H02K 9/19; H02K 11/33

(52) U.S. Cl. CPC E21C 31/02; E21C 25/10; F16H 1/46; H02K 11/33; H02K 7/116; H02K 9/19; H02K 1/20

(57) ABSTRACT

A drum-type shearer loader for the extraction of mineral material in the mining sector, has at least one shearer drum (1), which is mounted rotatably on a pivotable support arm (2) and which is driven by a drive motor (4) arranged at an end of the support arm (2), in the region of a support arm head (3). A compact drive unit for all operating states is provided with the drive motor (4) in the form of a permanent-magnet-excited synchronous machine which, during operation of the shearer drum (1), provides the entire drive power required for rotating the shearer drum (1).

### CROSS REFERENCE TO RELATED APPLICATIONS

This application is a United States National Phase Application of International Application PCT/EP2019/053414, filed Feb. 12, 2019, and claims the benefit of priority under 35 U.S.C. § 119 of German Application 10 2018 103 527.6, filed Feb. 16, 2018, the entire contents of which are incorporated herein by reference.

### TECHNICAL FIELD

The present invention pertains to a drum-type shearer loader for extracting mineral material, such as hard coal, salt or rocks, with at least one shearer drum or cutting drum, which is mounted rotatably at a pivotable support arm and which is driven by a driving motor arranged at the same end of the support arm. Furthermore, the present invention pertains to a shearer drum of a drum-type shearer loader with a drive unit.

### TECHNICAL BACKGROUND

Drum-type (drum) shearer loaders, which are also called at times drum-type loaders, are used in underground mining for the cutting extraction of minerals, especially hard coal or salts. At least one electric motor, which is normally integrated in the machine carriage, is used to drive all motion processes of the drum-type shearer loader. Drum-type shearer loaders in which the motor is arranged in the support arm are known as well. A shorter overall length of the drum-type shearer loader can be achieved with this configuration.

The shearer drums are usually located at the ends of the support arms, which are attached movably at both ends of the gearbox case. Means for force transmission, especially toothed gear cascades, with which the force is transmitted from the driving motor to a planet gear, via which the force is introduced into the shearer drum, are located in the support arms.

Water-cooled three-phase motors with a power of up to 230 kW are used, as a rule, as driving motors. The machine has, as a rule, an electric motor of its own for its propulsion.

In the prior-art drum-type shearer loaders, the shearer drums are attached each at the end of a pivotable support arm in the area of the so-called support arm head and are operated by an asynchronous motor with a synchronous speed of 1,500 rpm at a power grid frequency of 50 Hz or with a synchronous frequency of 1,800 rpm at a power grid frequency of 60 Hz.

A drum-type shearer loader for underground mining, in which the driving motors for the shearer drums are articulated each to the support arm head, is known from DE 38 22 875 A1. The shearer drums and the driving motors are arranged here at mutually opposite ends on the same side of the outer section of the support arm in the area of the support arm head and are connected to one another by gear elements located in the interior of this support arm section. Based on this arrangement, the driving motors are always located in the space cut free by the leading shearer drum.

Furthermore, a drum-type shearer loader, in which two driving motors arranged at spaced locations from one another are provided for driving the shearer drum, is known from DE 38 29 225 A1. One of these driving motors is located in the area of the support arm head, is connected via a multistage planet gear to the shearer drum and is arranged centrally in relation to the axis of the shearer drum. Since the driving power of this driving motor is too low to drive the shearer drum in different operating situations, an additional driving motor, which is connected via a wheel gear and a reducing gear to the shearer drum, is arranged at the opposite end of the support arm. The shearer drum of the drum-type shearer loader is usually driven by means of both driving motors. It is possible in a small number of cases of operation only to operate the shearer drum separating the seam with the weaker driving motor arranged towards the axis of the shearer drum.

It is problematic in the prior-art technical solutions for providing the driving power for shearer drums of a drum-type shearer loader that comparatively long paths must frequently be bridged over for transmitting the driving power from the driving motor to the shearer drum. Comparatively complicated and heavy force transmission means, which are therefore subject to losses, e.g., wheel gears, are necessary for this. Other technical solutions make provisions for a plurality of drive units, which transmit the driving power necessary for the respective different operating conditions to the shearer drum by means of complicated force transmission devices. The fact that the prior-art drive units provided in the area of the support arm head are without exception incapable of providing the power needed for the drive of the shearer drum shall be considered to be especially problematic in this connection.

### SUMMARY

Based on the solutions known from the state of the art for providing the driving power for the shearer drum of a drum-type (drum) shearer loader and on the above-described problems, a basic object of the present invention is to perfect a drum-type shearer loader such that a compact drive unit, which provides the driving power necessary for all operating situations and applications, is provided for the shearer drum. It is of great significance in this connection that the size and the section for the transmission of the driving power from the driving motor to the shearer drum are minimized and that a reliable, fail-safe operation of a drum-type shearer loader is made possible at the same time. In addition, the losses occurring in connection with the transmission of forces from the driving motor to the shearer drum should be as low as possible, so that an effective force transmission is achieved. Furthermore, simple maintenance and possibly repair of the drive unit should be ensured by the technical solution according to the present invention, and, in particular, the number of maintenance points needed and the distances between these points should be as low as possible.

The above object is accomplished with a drum-type shearer loader according to the invention. Advantageous embodiments of the present invention will be explained in more detail in the following description, partly with reference to the figures.

A drum-type shearer loader for the selective extraction of minerals with at least one shearer drum mounted rotatably at a pivotable support arm, which shearer drum is driven by a driving motor arranged at the same end of the support arm, has been perfected such that the driving motor is configured as a permanent magnet-excited synchronous machine (PMSM), which provides the power needed for the rotation of the shearer drum during an operation of the shearer drum. Due to the provision of a permanent magnet-excited synchronous machine as a driving motor, which is arranged at the support arm head, at which the shearer drum driven by it is located as well, a compact and high-power drive unit is made available for a shearer drum of a drum-type shearer loader, which drive unit is characterized by a comparatively small size and can nevertheless provide the driving power necessary for the rotation of the shearer drum in all operating situations. The driving motor is advantageously arranged in the area of the support arm head such that it is located on the opposite side of the shearer drum in relation to the support arm and is oriented at least nearly centrally in relation to the axis of rotation of the shearer drum. Depending on the particular application, permanent magnet-excited synchronous machines with powers between 250 kW and 2,000 kW are preferably used.

Due to the arrangement of the drive unit for a shearer drum with a permanent magnet-excited synchronous machine as a driving motor in the area of the support arm head, the section that is needed for the transmission of the power from the driving motor to the shearer drum is comparatively short, and, in particular, the often very long and technically complicated chain of gears is eliminated compared to the prior-art technical systems. Due to the preferred arrangement of the moving components of the drive system in the support arm head, the transmission of the rotary motion from the driving motor to the shearer drum along the moving support arm is, above all, eliminated. Loads that act on the support arm, such as bending and/or torsion, do not therefore act in the solution according to the present invention on the moving components of the drive system in the support arm head. This offers the additional advantage that the support arm itself can be configured as a construction with a comparatively low rigidity.

It is conceivable, in principle, that the driving motor is configured as an integrated motor, in which the motor housing is fully or at least partially integrated into the support arm, especially into the support arm head. In an alternative embodiment, the driving motor configured as a permanent magnet-excited synchronous machine is a separate structural unit, which is attached to the support arm head via a the motor housing or a flange. The diameter of the motor is preferably adapted to the width of the support arm in the area of the shearer drum. The diameter of the motor corresponds maximally to the width of the support arm in the most favorable case, so that an especially slim motor is obtained.

The use of a permanent magnet-excited synchronous machine (PMSM) as a driving motor arranged in the area of the support arm head of a drum-type shearer loader is also especially advantageous, because a comparatively simple cooling system is used. This can be attributed to the fact that no rotor cooling is necessary for this machine. Furthermore, no significant rotor losses occur in the permanent magnet-excited rotor.

Another advantage of the use of a permanent magnet-excited synchronous machine as a driving motor for the shearer drum of a drum-type shearer loader is that there is, as a rule, a markedly higher overload capacity compared to asynchronous machines, so that very high starting torques can be achieved with such a driving motor. Furthermore, the better power factor of the permanent magnet-excited synchronous machine compared to asynchronous machines leads to a lower current demand in the converter. Despite the fact that the driving motor is arranged in the area of the support arm head and in the therefore crowded space, it is possible based on the high power density of the permanent magnet-excited synchronous machine to provide in this area of the drum-type shearer loader a compact, high-power and effective drive unit, which can make available the driving power necessary at the shearer drum for all cases of operation and applications.

In a special embodiment of the present invention, the external diameter of the driving motor in the area of the support arm head is adapted to the diameter of the support arm head. According to this special embodiment, the diameter of the driving motor corresponds to the diameter of the support arm head and hence to the diameter of the hub of the shearer drum. In such a technical configuration, the motor diameter approximately corresponds to the length of the motor, so that an at least approximately cubic configuration of the motor housing is obtained.

According to a special variant, a permanent magnet-excited synchronous machine with a power of 800 kW is used in this connection as a driving motor in the area of the support arm head. Such an electric motor has a diameter of 800 mm to 1,000 mm and a length of 600 mm to 800 mm.

It is conceivable according to another special embodiment of the present invention that a miter gear is provided between the driving motor and the shearer drum, especially between the driving motor and a one-stage or multistage planet gear, which assumes the function of a reducing gear and is arranged in the area of the hub of the shearer drum. The longitudinal axis of the motor is bent at an angle relative to the axis of rotation of the shearer drum in this case, so that the longitudinal axis of the motor and the axis of rotation of the shearer drum form an angle. The angle formed is preferably at least approximately 90°.

In case of this arrangement of the driving motor relative to the shearer drum, the driving motor is preferably configured such that the diameter of the motor corresponds at least approximately to the width or depth of the support arm in the area of the support arm head. Slim motors are especially well suited for this reason for a configuration with miter gear. The torque, the speed as well as the size of the driving motor and/or the transmissions and sizes of the preferably two planet gears provided in the area of the shearer drum can also be adapted as needed in an especially suitable manner based on the transmission due to the miter gear. According to a special variant, a correspondingly arranged driving motor has a driving power of 800 kW. A corresponding, permanent magnet-excited synchronous motor has a diameter of 500 mm to 700 mm and a resulting motor length of 700 mm to 1,000 mm.

Regardless of the embodiment and arrangement according to the present invention of the driving motor in the area of the support arm head, it is advantageous if at least one and preferably two planet gears is/are provided between the driving motor, which is configured as a permanent magnet-excited synchronous machine, and the shearer drum. A torque introduced via a drive shaft is transmitted by means of the planet gear to a power take-off shaft for driving the cutting drum. This is a reducing gear, in which the ratio of the speed of the drive shaft to the speed of the power take-off shaft (=transmission) is greater than 1. The speed is thus reduced from the driving speed to the speed of the power take-off shaft.

Provisions are made in a special variant for the permanent magnet-excited synchronous machine provided as a driving motor in the area of the support arm head to have a high reluctance share. Three-phase synchronous machines with high reluctance share are characterized in that the torque is generated at least to a large part by the reluctance force, which is brought about by the magnetic conductivity of the rotary field generated by the stator, which conductivity varies along the circumference of the rotor, rather than, as is otherwise common, by the Lorentz force. According to a special embodiment of the present invention, a synchronous reluctance motor, which has a rotor that optionally has a flux barrier or distinct poles, is provided as a driving motor for the shearer drum of a drum-type shearer loader. In the synchronous reluctance motor, the torque is brought about almost exclusively by the reluctance force rather than by the Lorentz force, as in other synchronous machines. The rotor likewise rotates here synchronously with the rotary field of the supply network. A synchronous reluctance motor, which has a four-pole configuration, is preferably used.

In another special embodiment of the present invention, the driving motor configured as a permanent magnet-excited synchronous machine is fed at least at times by a frequency converter. The regulation of the permanent magnet-excited synchronous machine is preferably carried out here such that the driving motor is operated with the maximum torque and minimal current demand. The regulation is preferably carried out in this case on the basis of a vector regulation, by which it is achieved that the frequency converter, via which the permanent magnet-excited synchronous machine is fed, has an expanded speed and position accuracy compared to other regulations. The vector regulation is generally a regulation concept in which sinusoidal or largely sinusoidal alternating quantities, here the driving voltage or the driving current, are not regulated directly in terms of their instantaneous value over time, but in terms of an instantaneous value from which the phase angle within the period has been removed.

In reference to the driving motor configured according to the present invention as a frequency converter-fed synchronous machine, a d-q regulation is preferably used here. The d and q vectors are at right angles to one another, and the q value images the torque and the d value the magnetic flux density. The torque of the driving motor can be influenced in a suitable manner by q reference values predefined from the outside.

Provisions are made according to another embodiment of the present invention for the permanent magnet-excited synchronous machine used as the driving motor to be selected or configured, especially in reference to its stator and/or to its rotor, such that a high starting torque, which in turn brings about a high breakaway torque, be reached. It is preferably conceivable that the ratio of the starting torque to the nominal torque is selected in a range of 3.0 to 6.0. The following equation shall thus preferably be true in this case:

$$\frac{Starting torque}{Nominal torque} = 3.0 …6 .0 .$$

Furthermore, provisions are made in a special embodiment of the present invention for the driving unit to be configured such that the axes of rotation of the driving motor, of the at least one gear between the driving motor and the shearer drum as well as the driven shearer drum are parallel or especially preferably coaxial to one another. It is generally conceivable in this connection that a multistage planet gear and at least one additional gear stage are provided between the driving motor and the shearer drum. The multistage planet gear is preferably arranged within the hub of the shearer drum.

The present invention also pertains, furthermore, to a shearer drum for a drum-type shearer loader with a driving unit, which is in functional connection with the shearer drum. The shearer drum is mounted rotatably at the end of a pivotable support arm of a drum-type shearer loader for the selective extraction of minerals, especially hard coal and/or salts, and is connected to a driving motor, which is arranged at the same end of the pivotable support arm, i.e., in the area of the support arm head, and which is in connection with the shearer drum via means for torque and power transmission.

The shearer drum is characterized according to the present invention in that the driving motor is configured as a permanent magnet-excited synchronous motor, which provides a driving power that is sufficient for the operation according to the present invention of the cutting drum.

The essential idea of the present invention is based on the fact that a compact unit comprising a driving motor, means for power and torque transmission to the shearer drum is provided at the support arm head of a drum-type shearer loader. The use of a permanent magnet-excited synchronous motor as a driving motor for the shearer drum offers the advantage that a motor with a high power density is made available, which can be arranged in a space-saving manner in the area of the support arm head. The shearer drum may preferably be operated with driving motors with a power ranging from 250 kW to 2,000 kW depending on the particular intended use.

The present invention will be described below without limitation of the general inventive idea with reference to the figures on the basis of special exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a top view of the support arm of a drum-type shearer loader with a shearer drum and a driving motor of a slim configuration arranged at the support arm head;

FIG. 2 is a side view of the support arm with synchronous motor of a slim configuration, which is arranged opposite the shearer drum;

FIG. 3 is a top view of the support arm of a drum-type shearer loader with a shearer drum arranged at the support arm head and with a driving motor of a cubic configuration; and

FIG. 4 is a side view of the support arm with a synchronous motor of a slim configuration, which is arranged opposite the shearer drum and is connected via a miter gear to the shearer drum.

### DESCRIPTION OF PREFERRED EMBODIMENTS

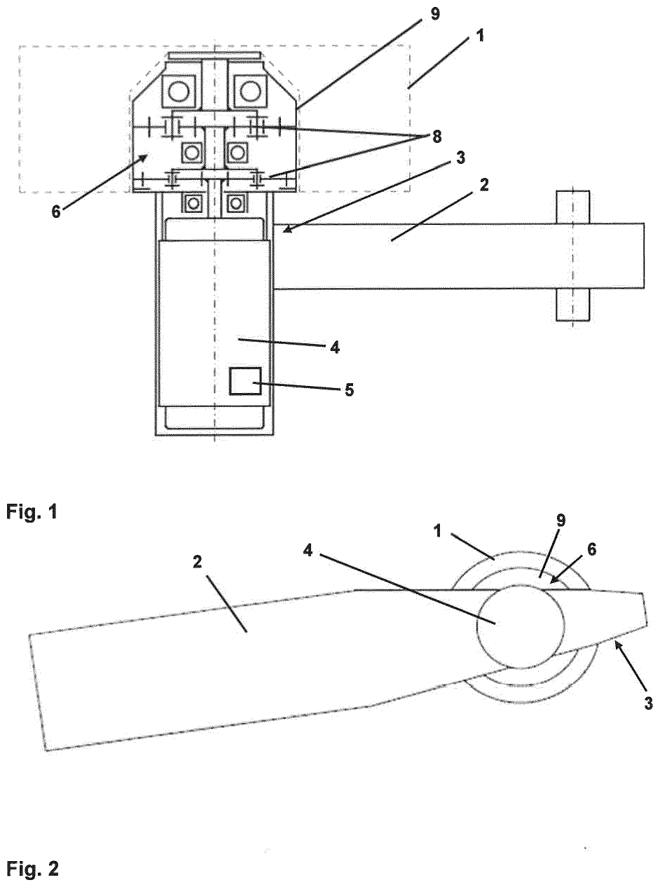

Referring to the drawings, FIG. 1 shows in a top view the pivotably mounted support arm 2 of a drum-type shearer loader, at which a shearer drum 1 and the drive thereof are arranged in the area of the support arm head 3. According to the exemplary embodiment shown, the shearer drum 1 is driven exclusively by means of a driving motor 4, which is configured as a permanent magnet-excited synchronous motor and is likewise arranged in the area of the support arm head 3. It is essential for the arrangement of the driving motor 4 relative to the shearer drum 1 that the axes of rotation of the driving synchronous motor 4, of the transmission gear 6, which has two planet gear stages 8, and of the shearer drum 1 extend coaxially to one another, and that the driving motor 4 is at least partially integrated into the support arm 2 on the side of the support arm 2 facing away from the shearer drum 1.

The permanent magnet-excited synchronous motor 4 shown schematically in FIG. 1 is configured as a slim motor, whose motor length exceeds the motor diameter. The driving motor 4 is integrated at least partially into the support arm 2, here in the area of the support arm head 3, which leads to an additional reduction of the space requirement, so that an especially compact and yet high-power driving unit is provided for the shearer drum 1 of a drum-type shearer loader.

The permanent magnet-excited synchronous motor 4, which is used as the exclusive drive of the shearer drum 1, is characterized by a high power density and is fed via a frequency converter 5, so that a reliable and precise starting as well as a reliable, tailor-made regulation of the driving motor 4 and hence of the rotation of the drum are guaranteed during the operation. Compared to the asynchronous motors usually used as a drive, a higher motor power is provided with the technical solution according to the present invention in an equal installation space. This is also the reason why driving powers of up to 2,000 kW, which bring about the rotation of the shearer drum 1, can be provided in the area of the support arm head 3 despite the provision of only one driving motor 4 bringing about the rotation of the shearer drum 1. It is thus possible to select the suitable permanent magnet-excited synchronous motor 4 from a power range of 250 kW to 2,000 kW corresponding to the requirements. Furthermore, the embodiment shown in FIG. 1, which is based on the present invention, is characterized by a comparatively short section, over which the power of the driving motor 4 is transmitted to the shearer drum 1. Complicated gear chains along the support arm 2 or other means, with which the rotation of the power take-off shaft of the driving motor 4 is transmitted to the shearer drum 1 over long sections, are therefore unnecessary.

The speed of the synchronous motor 4 shown is in the range of 800 rpm to 1,500 rpm, but it may be increased to a value of 5,000 rpm if the intended use of the drum-type shearer loader requires this, when selecting special motors.

Further, the gear stages of the transmission gear 6, which are used in the exemplary embodiment shown in FIG. 1 and are each configured as planet gears 8 in the area of the hub 9 of the shearer drum, are configured such that they provide an overall transmission of 30 to 40. It is additionally conceivable to arrange an additional gear stage with a transmission ranging from 2.5 to 3.5 in front of the two gear stages 6 in order to expand the overall transmission to a value of up to 140 in this manner.

FIG. 2 shows an additional representation of a side view of the arrangement of a shearer drum 1 with a permanent magnet-excited synchronous motor 4 as an exclusive drive in the area of the support arm head 3, which arrangement is described in FIG. 1. The driving motor 4 configured as a permanent magnet-excited synchronous motor can be seen in the side view according to FIG. 2 in an unobstructed view, while the shearer drum 1 is arranged on the opposite side of the support arm 2. The synchronous motor 4, having a slim configuration, is adapted, especially in terms of its diameter or of the external diameter of the motor housing, to the width of the support arm 2 in the area of the axis of rotation of the shearer drum. The diameter of the driving motor 4 thus corresponds at least approximately to the width or depth of the support arm 2 in this area.

A permanent magnet-excited synchronous motor 4 with an output power of 800 kW is used in the embodiment of the present invention shown in FIG. 2. Such a driving motor 4 of a slim configuration has a diameter in the range of 500 mm to 700 mm and a length of 1,200 mm to 1,400 mm.

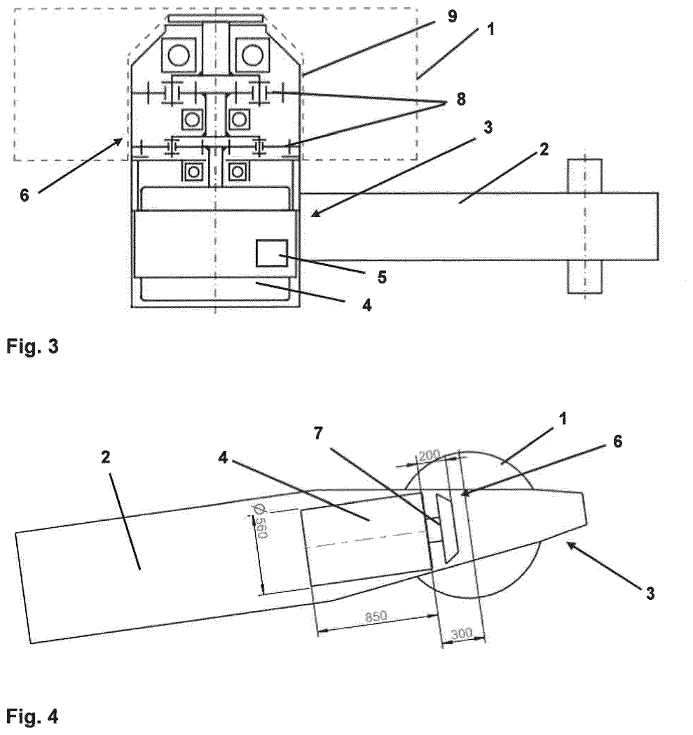

FIG. 3 shows another suitable embodiment of a driving motor 4 configured as a permanent magnet-excited synchronous motor for a shearer drum 1 of a drum-type shearer loader. The shearer drum 1 is driven or rotated in this case as well exclusively with the driving motor 4 arranged in this area of the support arm head 3. The axes of rotation of the driving motor 4, of the transmission gear 6 as well as of the shearer drum 1 likewise extend coaxially. Contrary to the driving motor 4 shown in FIG. 2, the driving motor 4 according to FIG. 3 has an at least nearly cubic configuration in relation to the dimensions of the motor housing. The diameter of the motor 4 as well as the length of the motor are thus at least approximately equal. The diameter of the driving motor 4 and of the motor housing corresponds in this embodiment at least nearly to the diameter of the support arm head 3 and hence also to the diameter of the hub 9 of the shearer drum 1. The advantage of this embodiment is that the width of the drum-type shearer loader is minimized in the area of the shearer drum 1.

A permanent magnet-excited synchronous motor 4 with an output power of 800 kW may likewise be used in the special embodiment of the present invention shown in FIG. 3. Such a motor 4 of a cubic configuration has a diameter in the range of 500 mm to 700 mm and a length of 1,200 mm to 1,400 mm.

FIG. 4 shows another possible arrangement of a permanent magnet-excited synchronous motor 4, which is a part of a drive train arranged at the support arm head 3 of the support arm 2 of a drum-type shearer loader. An essential feature of the arrangement shown in FIG. 4 is that the axis of rotation of the driving motor 4 forms an angle with the axis of rotation of the shearer drum 1, which angle preferably equals 90°. In order to make it possible to obtain such an arrangement, a miter gear 7 is provided as an additional component of the transmission gear 6 between the driving motor 4 and the shearer drum 1. The torque and power transmission from the driving motor 4 to the shearer drum consequently takes place via the miter gear 7 as well as the planet gears 8 arranged within the hub 9 of the shearer drum.

According to the embodiment shown in FIG. 4, the diameter of the driving motor 4 is again adapted to the dimensions of the support arm 2. The diameter of the motor 4 corresponds, in particular, essentially to the width or depth of the support arm 2 in the area of the support arm head 3. The corresponding dimensions are shown in FIG. 4.

The provision of a miter gear 7 between the driving motor 4 and the shearer drum 1, both of which are arranged in the area of the support arm head 3, offers the possibility of optimizing the torque, the speed as well as the overall size of the motor and/or the transmission and the overall size of the planet gears 8 arranged in the area of the hub of the shearer drum. If a permanent magnet-excited synchronous motor 4 with an output power of 800 kW is used for the embodiment according to FIG. 4, this has a diameter of 500 mm to 700 mm, here 560 mm, and a resulting motor length of 700 mm to 1,000, here 850 mm.

While specific embodiments of the invention have been shown and described in detail to illustrate the application of the principles of the invention, it will be understood that the invention may be embodied otherwise without departing from such principles.

1. A drum shearer loader for extracting mineral material in mining, the shearer loader comprising:
a pivotable support arm;
at least one shearer drum is mounted rotatably in the pivotable support arm, at a support arm end;
a driving motor arranged at the support arm end in an area of a support arm head, wherein the driving motor is configured as a permanent magnet-excited synchronous machine, which provides a total driving power needed for rotation of the shearer drum during operation of the shearer drum.

2. A drum shearer loader in accordance with claim 1, further comprising a frequency converter configured to at least at times feed the driving motor.

3. A drum shearer loader in accordance with claim 2, wherein the frequency converter is configured to regulate the driving motor on the basis of a maximum torque and/or of a minimum current demand as a command variable.

4. A drum shearer loader in accordance with claim 3, wherein the regulation of the driving motor is based on a vector regulation.

5. A drum shearer loader in accordance with claim 1, wherein starting torque is made available by the driving motor at least at times, so that a ratio of the starting torque to the nominal torque assumes a value of 3.0 to 6.0 and
$$\frac{Starting torque}{Nominal torque} = 3.0 … 6.0 ,$$
is thus true.

6. A drum shearer loader in accordance with claim 1, further comprising a transmission gear, with at least one gear stag, provided between the driving motor and the shearer drum.

7. A drum shearer loader in accordance with claim 1, wherein an axis of rotation of the driving motor is oriented coaxially to the axis of rotation of the shearer drum.

8. A drum shearer loader in accordance with claim 6, wherein an overall transmission of the transmission gear with at least one gear stage has a value of 30 to 40.

9. A drum shearer loader in accordance with claim 6, wherein the transmission gear has at least one planet gear.

10. A drum shearer loader in accordance with claim 1, wherein the transmission gear comprises a miter gear between the driving motor and the shearer drum.

11. A drum shearer loader in accordance with claim 10, wherein the miter gear has a transmission ranging from 1.1 to 5.0.

12. A drum shearer loader in accordance with claim 1, wherein the driving motor is integrated at least partly into the support arm.

13. A drum shearer loader in accordance with claim 1, wherein the driving motor has water jacket cooling of the stator providing an only added means of cooling.

14. A drum shearer loader in accordance with claim 13, wherein the water jacket cooling of the stator is connected to the cooling system of the shearer drum and/or is operated with the same cooling liquid as the cooling system of the shearer drum.

15. A drum shearer loader in accordance with claim 1, wherein the driving motor configured as a permanent magnet-excited synchronous machine has a high reluctance share.

16. A shearer drum, which is mounted rotatably at a support arm head of a pivotable support arm of a drum shearer loader for a selective extraction of minerals, the shearer drum comprising:
a driving motor arranged at the support arm head of the pivotable support arm and is in functional connection with the shearer drum via means for torque transmission, wherein the driving motor is configured as a permanent magnet-excited synchronous motor, which provides a total driving power necessary for rotating the shearer drum during the operation of the shearer drum.

17. A drum shearer loader in accordance with claim 4, wherein the regulation of the driving motor is based on a d-q regulation.

18. A drum shearer loader in accordance with claim 6, wherein an axis of rotation of the driving motor is oriented coaxially to an axis of rotation of the transmission gear arranged between the driving motor and the shearer drum.

19. A drum shearer loader in accordance with claim 6, wherein an axis of rotation of the driving motor is oriented coaxially to an axis of rotation of the shearer drum and to an axis of rotation of the transmission gear arranged between the driving motor and the shearer drum.

20. A drum shearer loader in accordance with claim 6, wherein the transmission gear comprises two planet gears.
